(19) United States
(12) Patent Application Publication
(10) Pub. No.: US 2017/0236201 A1
(43) Pub. Date: Aug. 17, 2017

(54) SYSTEMS AND METHODS FOR DETECTING ADVANCE EARNING INSIDER INFORMATION

(71) Applicant: Anthony D. Kolton, Park Ridge, IL (US)

(72) Inventor: Anthony D. Kolton, Park Ridge, IL (US)

(21) Appl. No.: 15/429,485

(22) Filed: Feb. 10, 2017

Related U.S. Application Data
(60) Provisional application No. 62/294,162, filed on Feb. 11, 2016.

(51) Int. Cl. G06Q 40/04; G06Q 10/10

(52) U.S. Cl. CPC G06Q 40/04; G06Q 10/1095

(57) ABSTRACT

A web-based, research tool that allows users to build dashboards combining screening analysis and event driven analysis is disclosed. The screening criteria can include both fundamental and significant technical analysis events. Users may build their own dashboards on whatever instruments they desire that are within the system. A dashboard is a set of selected tickers organized by event dates. Each ticker on the dashboard displays up to eight technical indicators. At least one of the technical indicators are derived from company insider information originating within social media, and the visual mapping is constructed as a time-sequenced, set of squares colored with a limited set of colors representing a set of conditions uniform to all technical indicators and juxtaposed as a map to predict the price direction of stocks and other assets.

### PRIORITY CROSS-REFERENCE TO RELATED APPLICATIONS

This application claims priority pursuant to 35 U.S.C. 119(e) from U.S. Provisional Patent Application No. 62/294,162 filed on Feb. 11, 2016.

### FIELD OF THE INVENTION

The present inventions relate generally to automated information search, retrieval and reporting systems and methods, and more particularly, to systems and methods of mapping market and/or financial indicators combined with detected insider information to predict behavior.

### BACKGROUND OF THE INVENTION

Traders, portfolio managers, investors, market analysts, and other market players commonly utilize historical data to analyze past market behavior and to predict future market behavior in a process known as backtesting. Database systems that aid in the use of backtesting are well known.

U.S. Pat. Nos. 5,414,838, 5,590,325 and 5,778,357, all of which are incorporated herein by reference in their entirety, disclose a system and method for querying commodity price (e.g. stock price) information databases. A user provides a query specifying trading date attributes, including calendar events, such as national holidays and triple-witching hours, and/or fundamental events such as dates of political elections, dates a particular stock had a closing price above or below a certain level, dates of company earnings reports, dates of release of economic information (e.g. consumer price index) and so on. The query can be provided in a near natural language format, and reports from the query can be viewed in either tabular or graphic form.

Additionally, from the historical data, the traders, portfolio managers, investors, market analysts, and other market players analyze technical indicators, which are any class of metrics whose value is derived from generic price activity in a stock or asset. Technical indicators look to predict the future price levels, or simply the general price direction, of a security by looking at past patterns.

News and rumors are also recognized as able to affect the stock market. U.S. Pat. No. 6,709,330 to Klein, et al. for Stock Simulation Engine for an Options Trading Game, issued Mar. 23, 2004, provides “a news/rumor generator for moving stock prices” to simulate real life news events and rumors. Additionally, the effect of historical events on prices is known. U.S. Patent Application No. US 2007/0050273 from Burke, J R., for “System and Method for Presenting Price Movements Before or Following Recurring Historical Events”, published Mar. 1, 2007, provides for “Computer systems and methods handling information about price movements of a financial instrument before or following a recurring historical event by specifying target financial instruments, recurring historical events, and computing returns of financial instruments each relative to a substantially single respective reference time, for a plurality of distinct times during a respective time period in proximity to a time of the respective prior occurrence.”

In more recent years, with the advent of social media websites, such as Facebook™, Twitter™, and LinkedIn™, a new avenue exists to find data that one may analyze to predict price movement. For example, U.S. Patent Application No. US 2012/0246054 from Sastri, for “Reaction Indicator for Sentiment of Social Media Messages”, published Sep. 27, 2012, defines a reaction indicator that combines sentiment and intensity data relating to an asset for use in real-time evaluation of publicly traded equities and commodities. The reaction indicator includes graphic objects displayed upon a monitor that depict social media market sentiment and intensity. The graphic objects are spheres where the graphic object changes color based upon sentiment and changes size based upon intensity. Sastri further defines a reaction indicator including a central graphic object visualizing a weighted average of all graphic objects based on weights assigned to the graphic objects.

While new avenues, such as social media, may have produced new sources for data and for technical indicators, and while aspects of the technical indicators may be measured by color and size, and perhaps other signals, the prior art has ignored the interdependencies between and among the new and old sources for data and the new and old technical indicators. Consequently, the prior art does not define how these interdependences may be visually shown. Furthermore, while Sastri discloses a measure of sentiment and intensity from social media, Sastri, and the prior art, does not disclose deciphering social media data for insider information leaks, such as that which may appear in a company's earnings reports.

Accordingly, it would be desirable to create a visual mapping of multiple technical indicators, including both traditional technical indicators and new technical indicators, where at least one of the new technical indicators are derived from company insider information originating within social media, and where the visual mapping is constructed as a time-sequenced, set of squares colored with a limited set of colors representing a set of conditions uniform to all technical indicators and juxtaposed as a map to predict the price direction of stocks and other assets. The inventions discussed in connection with the described embodiment address these and other deficiencies of the prior art.

The features and advantages of the present inventions will be explained in or apparent from the following description of the preferred embodiment considered together with the accompanying drawings.

### SUMMARY OF THE INVENTION

The present inventions address the deficiencies of the prior art of financial technical analysis. The present invention relates to the rate of acceleration or deceleration of observed technical indicators, such as RSI, MACD, OBV, MNF, Range, and Trend. See definitions from “The Encyclopedia of Technical Market Indicators” by Colby. An additional technical indicator is derived from social media, such as Twitter and other social media, from observed sentiment and other factual information, which is then measured, analyzed and quantified for analog pattern recognition overlays to detect advance earning report insider information that will impact financial transactions. These social media based indicators may also be referred to as S-Scores. Additionally, Super-Analog may be used. “Classic” analog looks at the last fifty days of a stock to predict the next fifty days. “Super analog” looks at the last fifty days of a stock, the last fifty days of an index (DOW, S&P, etc.) and any other current economic indicators that a user may want to add such as unemployment numbers, GDP Growth, Inflation, etc. to predict the next fifty days of a stock. In the present inventions, at least one of the technical indicators are derived from company insider information originating within social media, and the visual mapping is constructed as a time-sequenced, set of squares colored with a limited set of colors representing a set of conditions uniform to all technical indicators and juxtaposed as a map to predict the price direction of stocks and other assets.

Embodiments of the present inventions include programmed computer-implemented systems and methods having an information producer that produces one or more source-related information records from one or more information providers in computer readable format with each source-related information record containing the name of the source, the subject matter of the source-related information record, the current date, a release date when the source will release a report containing information concerning the subject matter of the source-related information record, and a plurality of links configured to attach further information as a recorded date and a discreet category from a set of categories to the source-related information record. Described embodiments involve a company as the source, earnings as the subject matter and linking very bullish, bullish, neutral, bearish, very bearish, and no information as the categories.

A social media monitor communicates with the information producer and monitors one or more social media sources, such as Twitter. The social media monitor has an input process configured to receive the current date, the name of the source and the subject matter of the source-related information record from the information producer for each of the one or more source-related information records and a query process configured to monitor each of the one or more social media sources to find daily social media information about the source and the subject matter of the source-related information record and link the current date as a recorded date and the daily social media information found to the source-related information record for each of the one or more source-related information records. In the described embodiments, the social media sites are searched for earnings related information shortly before the earnings reports are released for companies.

A scheduled event manager communicates with the information producer and the social media monitor to set a first tunable number to the number of days before the current date for which to store daily social media information from the social media monitor and to create a second tunable number of particular discrete categories into which a process may categorize the daily social media information. The one or more source-related information records correspond with the linked recorded dates and daily social media information for each recorded date. A categorization process finds the linked recorded date and daily social media information for each of the one or more source-related information records for each of the recorded dates in each record from the first tunable number of days before the current date to the current date, categorizes the found relevant daily social media information into one of the particular discrete categories and links the particular discrete category to the source-related information record. In the described embodiments, this links a number of day's worth of social media earnings-related information and respective category to the record for the company.

An output manager is used to communicate with the scheduled event manager, for each of the one or more source-related information records, to output the name of the source, the subject matter of the information, and for each of the links within each source-related information record with recorded dates from the date the first tunable number of days before the current date to the current date to output the recorded date and the particular discrete category. In the described embodiments, a number of day's worth of social media earnings-related information and respective category are output.

A computerized video display may be used with a graphical output interface in communication with the output manager and configured to show on the video display for each source-related information record the name of the source, the subject matter of the source-related information record, the release date, the current date, and a graphical representation of the particular discrete category. The system further has the graphical output interface configured to show on the video display for each of the one or more source-related information records, the name of the source, the subject matter of the information, and for each of the links within each source-related information record with recorded dates from the date the first tunable number of days before the current date to the current date output the recorded date and the graphical representation of the particular discrete category. The graphical output interface may further be configured to show graphical representations of values pertaining to categories related to the category of daily social media information that can be graphically represented with the same particular discrete categories as the daily social media information wherein the graphical representations of values pertaining to the related categories are juxtaposed in relation to the graphical representation of the daily social media information to give the graphical representations of values pertaining to the related categories and the graphical representation of the daily social media information meaning based on the juxtaposition. In the described embodiments, the user will see the categorized graphics arranged to show changing information from social media and related technical indicators in a single line of graphics of different colored squares.

The systems and methods further configure the output manager and the graphical output interface to, for a source-related information record for each of the recorded dates from the first tunable number of days before the current date to the current date, create a graphical arrangement by graphically arranging on the computerized video display for visual scanning the juxtapositions of the graphical representations of values pertaining to the related categories and the graphical representation of the daily social media information. In the described embodiments, the user will see a rectangular arrangement of the lines described in the previous paragraph aligned vertically in a time sequence of several days.

The output manager and the graphical output interface may also, for each of the one or more source-related information records, juxtapose the corresponding graphical arrangements to give the graphical arrangements meaning based on the juxtaposition. In the described embodiments, the user will see a matrix of the rectangular arrangements described in the previous paragraph.

The graphical output interface may further display the juxtaposition of the graphical representations of values pertaining to the related categories and the graphical representation of the daily social media information as a user interface dashboard arranged according to release dates.

The categories related to the category of daily social media information are the following technical indicators: On Balance Volume (OBV), Chaikin Money Flow (MNF), Moving Average Convergence/Divergence (MACD), Relative Strength Index (RSI), Percentage of last Close within the High-Low Range (Range), a comparison of moving averages versus price (Trend) and the predicted price movement in the next ten days (Analog).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The inventions will now be more particularly described by way of example with reference to the accompanying drawings. Novel features believed characteristic of the inventions are set forth in the claims. The inventions themselves, as well as the preferred mode of use, further objectives, and advantages thereof, are best understood by reference to the following detailed description of the embodiment in conjunction with the accompanying drawings, in which:

FIG. 1 shows the main menu for a system of dashboards.

FIG. 2 shows a dashboard panel.

FIG. 3 shows a date input box and a search box.

FIG. 4 shows a page for creating a watchlist.

FIG. 5 shows a blank dashboard wizard for building dashboards.

FIG. 6 shows a list of tickers in the dashboard wizard that will appear on the dashboard.

FIG. 7 shows a sample dashboard of instruments organized by dates relevant to the instrument.

FIG. 8 shows a price graph customized to show specific markers on days that have certain events.

FIG. 9 shows an analysis window displaying the mapped indicators.

FIG. 10 shows a stock chart with an analysis component and a graph component.

FIG. 11 shows a main price graph with indicator graph toggle buttons and event markers.

FIG. 12 shows a real time graph of the current day's trading with several technical indicators mapped.

FIG. 13 shows a sample score page.

FIG. 14A shows a sample heat map page of mappings from a dashboard.

FIG. 14B shows a single block map view of a single stock enlarged over the heat map.

FIG. 15 shows the Earnings Dashboard.

FIG. 16 shows ticker symbol information over a selected stock.

FIG. 17 shows a watchlist of stocks.

FIG. 18 shows an analysis window with a “sixth day” column.

### DETAILED DESCRIPTION OF THE EMBODIMENTS

The theory behind the present inventions is that earnings information leaks the week before a company releases its actual earnings report via a “flash report”. So, the described embodiments provide a novel way to watch certain technical indicators that have been found and tested as relevant. For example, the CFO of a company will hold intense discussions with the accounting department, outside auditors, press agents, lawyers, etc. in a frenzy to refine the flash report number. The accounting rules are so flexible, there are a lot of ways to increase or decrease the preliminary number. There are many meetings with a lot of people with some of these meetings lasting until midnight and beyond.

These numbers leak. So, as these discussions take place, and insiders pass along the information to their brothers, sisters, fathers and mothers and aunts and uncles, by using technical indicators based on these leaks, and people trade on this information, one can detect the likely results on the announcement day. As these indicators become bearish or bullish each day, and as the actual release approaches, the described embodiments will allow a user to see boxes to the left of a price chart that will turn colors, red for bearish, green for bullish and yellow for neutral to show the changing technical indicators. Not only is the final day's color important, but how these colors change each day as the report release day approaches is also important. More red boxes indicate a probable miss and more green boxes a probable beat.

As an overview, the described systems and methods work as follows. Once one starts the described embodiment, the user may select EARNINGS at the top middle of the screen. The user will see tickers for all the stocks coming out with earnings in the near future. Selecting a ticker will cause a chart of the stock to appear. An analysis window to the left of the chart will show with technical scores color coated as previously discussed. Next, the user may cull the list down to just a few stocks and watch them like a hawk on the day before reports are released, which represents the last day one can place a bet on the stock. The described embodiments may also use a three-minute bar charts for a unique look.

The described embodiment is a web-based, research tool that allows users to build dashboards combining screening analysis and event driven analysis. The screening criteria can include both fundamental and significant technical analysis events. For example, one may want to find all large cap technology stocks that have recently crossed above their 52 week moving average. Results are organized in “dashboards,” and users can drill down to see technical analysis of the instruments within the described embodiment. These instruments include: stocks, commodities, or exchange-traded funds (ETFs).

The described embodiment calculates a T-Score, which is a single number that summarizes a technical analysis window using user specified weights for different days and different indicators. T-Scores range from −100 to 100 and cluster around 0. Very positive T-Scores are indicative of upward price pressure and conversely very negative T-Scores are indicative of a downward trend in price. The Net T-Score is the T-Score subtracting the market bias (BETA) of a stock before the T-Score is computed.

The described embodiment appeals to all types of users including traders, analysts, and quants who will find the described embodiment an effective research tool. The described embodiment is an active piece of software for use in an up to date browsers, such as Chrome, Safari, Firefox, and the like. Before using the described embodiment, one must create an enterprise account or join an account to be able to log in.

The described embodiment allows users to build their own dashboards on whatever instruments they desire that are within the system. In the described embodiment, a dashboard is a set of selected tickers organized by event dates. Each ticker on the dashboard displays up to eight technical indicators, and the most recent values appear as eight colored boxes underneath each ticker symbol on a dashboard. In other embodiments, a different number of technical indicators may be used. In the described embodiment, these technical indicators are calculated daily for all instruments used in the systems or methods.

These indicators are, from left to right, as follows:
On Balance Volume (OBV) measures buying and selling pressure as a cumulative indicator that adds volume on up days and subtracts volume on down days.
Chaikin Money Flow (MNF) measures buying and selling pressure for a given period of time. A move into positive territory indicates buying pressure, while a move into negative territory indicates selling pressure.
Moving Average Convergence/Divergence oscillator (MACD) turns two trend-following indicator moving averages into a momentum oscillator by subtracting the longer moving average from the shorter moving average.
Relative Strength Index (RSI) is a momentum oscillator that measures the speed and change of price movements.
Range (Range) is the percentage of last close within the High-Low range.
Trend (Trend) is a comparison of the 9, 18, 50, and 200 day moving averages vs. the current price.
Social Media (Social Media) is the sentiment of the stock on Twitter™ using an S-score. The S-score is the normalized representation of a stock's sentiment time series over a look back period. For example, define a look back period, such as three months, find the mean and standard deviation of the daily sentiment, and then the s-score is the number of standard deviations today's sentiment is from the mean.
Analog is the predicted price movement of the next ten days. To do this prediction, one must train a support vector machine using a radial basis function kernel to predict the percent move of a stock from today to the next N days, given the movement of the stock over a look back period, e.g., three months. Then the support vector machine is used to predict the movement of the stock using the most recent look back period.

Other embodiments may have more or fewer indicators and allow users to build their own indicators.

In the described embodiment, every dashboard comes with a set of pages. These pages include: a map page of the dashboard, a stock chart page for each ticker on the dashboard, a score page for the dashboard, and a backtesting page for the dashboard. Each of these pages is described below. No matter what dashboard the user builds, these pages function the exact same way for every dashboard.

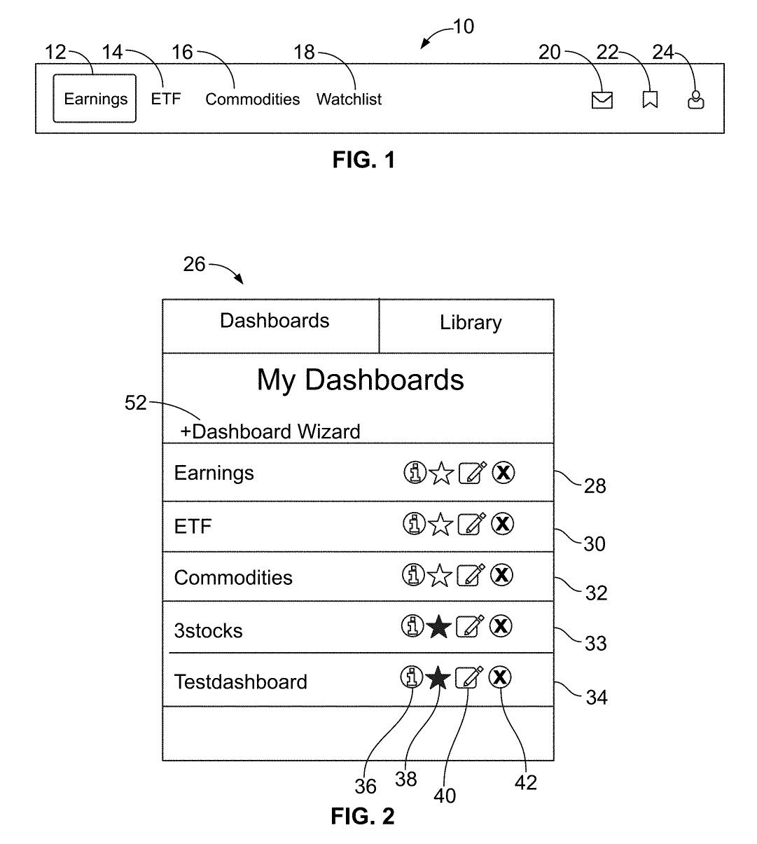

FIG. 1 shows the main menu for a system of dashboards. In the described embodiment, the main menu 10 can have up to five dashboards. In other embodiments, other numbers of dashboards may be used. By default, when a user signs up, the main menu 10 is made up of three built-in dashboards, Earnings, ETFs, and Commodities, which a user may access by choosing the Earnings icon 12, ETF icon 14, or the Commodities icon 16, respectively. Other combinations of built-in dashboards may be used. In the described embodiment, these built-in dashboards cannot be edited or deleted by the user. By default, in the described embodiment, the first dashboard on the main menu is also the one highlighted/selected when the user logs in. Other embodiments may allow one to edit or delete built-in dashboards. The main menu 10 further has a watchlist icon 18, a messaging icon 20, a dashboard icon 22, and user icon 24. The functions of these icons are explained below.

FIG. 2 shows a dashboard panel. If the user selects the dashboard icon 22, as shown in FIG. 1, the dashboard panel 26 appears. Users can create, edit, delete, make a favorite, or get information about any dashboard by using the dashboard icons on the dashboard panel 26. The dashboard panel 26 has selection bars for the built-in dashboards, the Earnings selection bar 28, the ETF selection bar 30, and the Commodities selection bar 32. The dashboard panel 26 also has selection bars for user created dashboards. FIG. 2 shows one user created selection bar 33 for the user created dashboard named “3stocks”, and one user created selection bar 34 for the user created dashboard named “Testdashboard”. The described embodiment may have many user created dashboards. Each dashboard selection bar has four buttons, an information button 36, a favorite button 38, an edit button 40, and a delete button 42.

In the described embodiment, users can have up to five “favorite” dashboards, which are always on the main menu 10 (from FIG. 1). The favorite button 38 is denoted in the dashboard panel 26 by a star. At any time, the user can make any dashboard a favorite by simply clicking the favorite button 38 icon of the dashboard and waiting for the star to toggle to a different color. This dashboard now becomes one of the five dashboards on the main menu 10 (from FIG. 1). If the user already has five favorite dashboards and wants to change one of his or her five favorite dashboards, he or she would simply turn off one of their favorite dashboards by toggling (clicking on) the favorite button 38 (yellow star) and make another of their dashboards one of their favorites.

Users can delete any of their created dashboards at any time by selecting the delete button 42 of the dashboard they want to delete and a modal will pop up asking for verification. If the user clicks the “Delete” button on the verification modal, the dashboard will be deleted. If the user clicks the “Cancel” button on the verification modal, the dashboard will not be deleted. If the dashboard that is deleted exists on the main menu 10 (from FIG. 1), that menu item will also be deleted from the main menu 10 (from FIG. 1).

When a user builds a dashboard, the user names the dashboard and can give a short description of the dashboard. The dashboard also gets a create date. Every time the user edits the dashboard, it gets an edit date also. Hovering over the information button 36 will display a modal giving the user this information.

Even if the dashboard is not a favorite, the user can still go to any of the pages of a dashboard. To go to one of these pages for a dashboard that is not a favorite, the user simply needs to click on the dashboard name in the dashboard panel 26 and a dashboard menu will display with the title of the dashboard with all of the available pages. In the described embodiment, the dashboard menu displayed is the same for all dashboards, as described below.

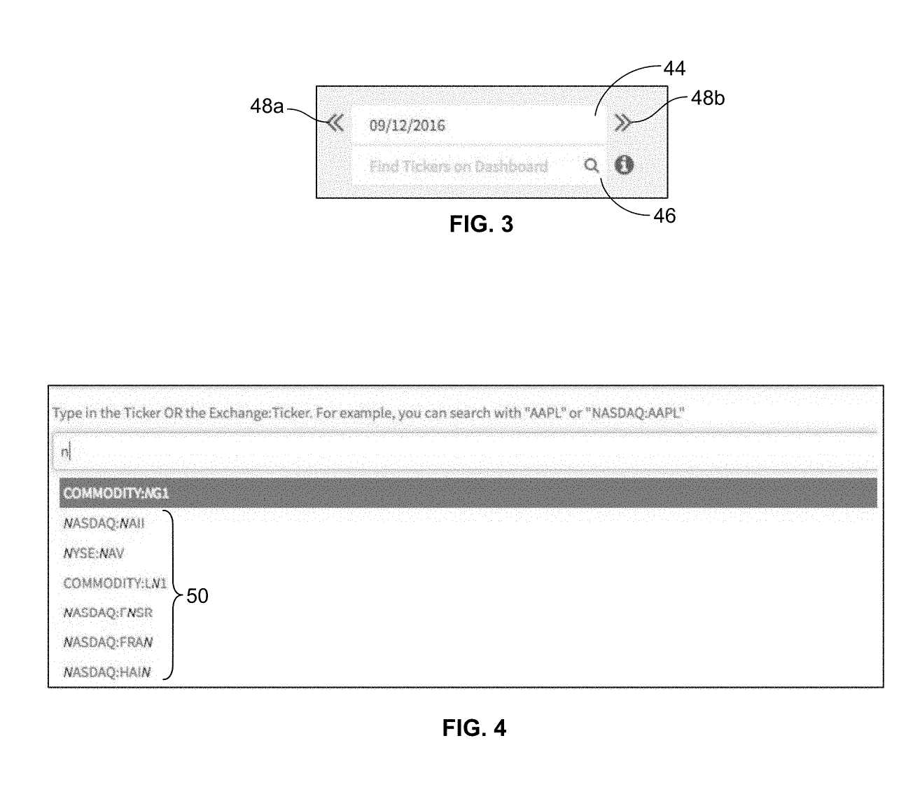

FIG. 3 shows a date input box and a search box. Every dashboard has a date input box 44 and a search box 46. The date input box 44 defaults to the current date, but the user can input any date in the past to see the events on the dashboard for that date. Using the “<<” and “>>” icons 48a-b on the date input box 44 allows the user to easily navigate the days. The search box 46 is used to find tickers on the dashboard and works by first looking for the requested ticker on all the current pages of the dashboard. If the search fails to find the ticker on the current pages of the dashboard, it finds the last time the ticker appeared on the dashboard.

FIG. 4 shows a page for creating a watchlist. In the described embodiment, users can put up to twelve tickers from any of their favorite dashboards on a watchlist at any time. Every ticker uses its exchange. So, for example, if there is an ETF and NASDAQ equivalent ticker, the application allows this. When the user selects the watchlist icon 18 (from FIG. 1) from the main menu 10 (from FIG. 1), it takes a second or two for the watchlist to auto-populate with all of tickers from the user's favorite dashboards 50. Once the watchlist is populated, the user can start typing a ticker symbol, and the tickers from the user's favorite dashboards 50 that match will appear. See below for more information on how the watchlist works.

Referring back to FIG. 2, to build a dashboard, select the dashboard icon 22 from the main menu 10 (from FIG. 1). A dashboard panel 26 slides into view and lists, in alphabetical order, all the user's dashboards. Select the dashboard wizard icon 52 to bring up the dashboard wizard. The dashboard wizard slides into view on the left side of the page to begin.

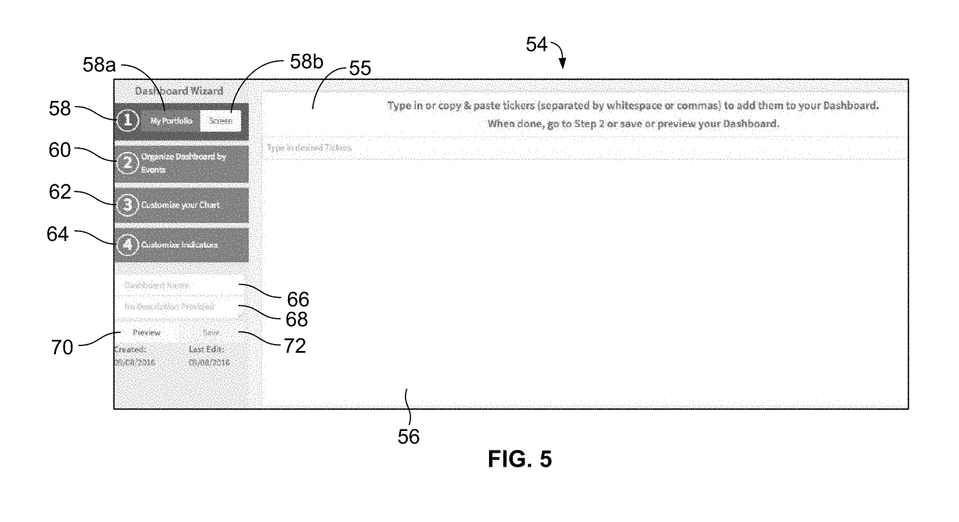

FIG. 5 shows a blank dashboard wizard for building dashboards. Initially, the blank dashboard wizard 54 appears when the user selects the dashboard wizard icon 52 (from FIG. 2). The blank dashboard wizard 54 allows a user to create a list of items, stocks for example, to watch on a dashboard. The blank dashboard wizard 54 has a text input box 55 for entering the items to watch, a listing area 56 to list the items chosen to watch, a dashboard name box 66 for entering the dashboard name, a description box 68 to describe the dashboard that the user is creating, a preview button 70 to view the created dashboard, and a save button 72 to save the dashboard. Building a dashboard using the dashboard wizard requires four step.

In the first step, the user adds a portfolio or screens items by selecting the portfolio/screen button 58. Once the portfolio/screen button 58 is selected, users can either a) enter a portfolio of tickers by typing them in or copying and pasting them from another document into the ticker area or the text input box 55 or they can b) screen on all the stocks currently within the NASDAQ or NYSE exchanges. The user can also screen on ETFs and Commodities available in the application. If the user wants to enter portfolio data, the user selects the My Portfolio button 58a, and if the user wants to screen, the user selects the Screen button 58b.

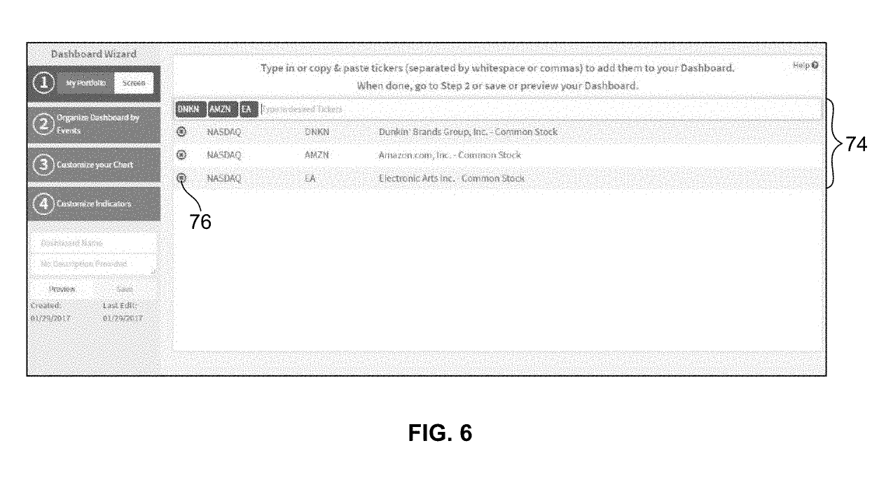

To build a dashboard of tickers for a specific portfolio is simple. By default, the portfolio/screen button 58 is set with the My Portfolio button 58a selected. In the described embodiment, it is green. When a ticker has been entered into the text input box 55, the ticker, its exchange, and its full name will appear right below the text input box 55. This is shown in FIG. 6 as a list of tickers 74, where FIG. 6 shows a list of tickers in the dashboard wizard that will appear on the dashboard. Referring to both FIG. 5 and FIG. 6, the user can continue to append to the list of tickers 74 by putting the cursor at the end of the ticker list in text input box 55 and typing or copying and pasting in more tickers. The user can remove a ticker from the listed tickers by selecting the delete icon 76. When all the tickers of a portfolio have been added as the user likes, the user should select the event organizer button 60.

Still referring to FIG. 5, instead of entering a specific portfolio of tickers, the user has the option to select the Screen button 58b. Screening allows the user to filter all 8,000 tickers on the major exchanges based on user-defined metrics. The user can select trading instruments, such as stocks, ETFs, or Commodities, that fit a certain profile or set of criteria. To select screening, simply select Screen button 58b and a list including stocks, ETFs, or Commodities will appear below the Screen button 58b. The user can then choose what instrument to screen.

The screener has three columns. Column 1 of the screener allows the user to pick a category of screeners, such as Favorites/Most Popular, Company Descriptors, Size & Share Volume, Price and Price Changes, Scores, Earnings, Sales and Growth Estimates, Valuations, Return on Investment, Income Statement and Growth, Dividends, Margins and Turnover, and Balance Sheets, although other categories are possible.

The available screeners under the selected category will display in column 2 with the category header. For example, if a user selects, Size & Share Volume, column 2 will show, “Size & Share Volume” on top with Shares Outstanding, Market Cap, and Average Volume shown below. If the user selects the desired screeners from column 2, the desired screeners will be added to column 3. Most screeners can be customized by specifying a numeric range or by selecting parameters from the screener itself, such as Market Cap. The user can remove a screener by clicking on the “Delete” icon of the selected screeners. The current screening criteria can be read from column 3. For example, the user can use the columns to select all stocks that are in the S&P 500 and that are in the Computer and Technology Sector and that have a market cap between 200K and 400K.

In the described embodiment, all selected screeners in column 3 are “anded” together, meaning they will display on the dashboard if they match all of the selected screeners. Another way to say this is: stocks are selected for the dashboard only if they match all the criteria. If the user does not know how a screener option is defined, the user can select an informational icon and a tip will tell them the definition. In an example, the user can make an available screener in column 2 a “favorite” by clicking on the favorite icon to the left of the screener and toggling it to a color, such as yellow.

Still referring to FIG. 5, when all screeners have been added as the user likes, the user should select the event organizer button 60 to organize the dashboard by events.

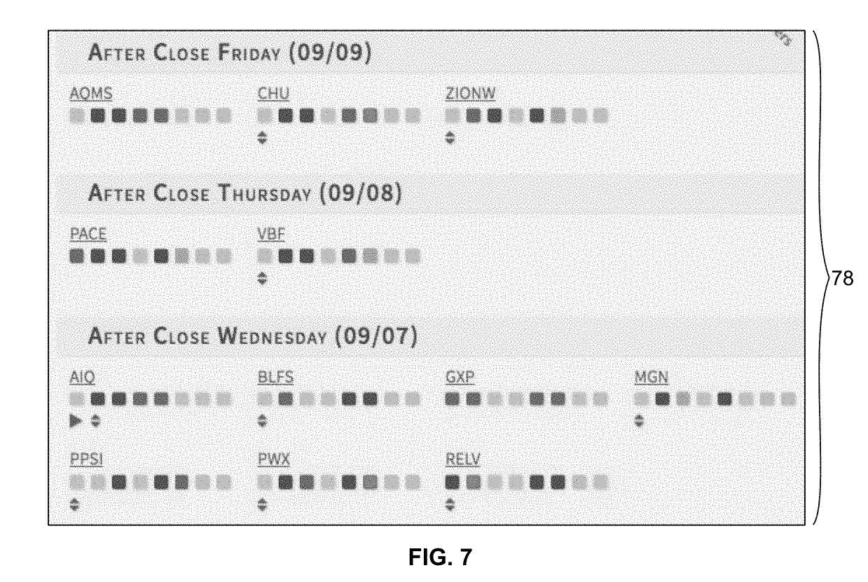

FIG. 7 shows a sample dashboard of instruments organized by dates relevant to the instrument. The instruments that pass the screening or portfolio criteria above are organized by dates that are relevant to those instruments as shown in a sample dashboard of instruments organized by dates 78. For example, stocks may be listed under important dates such as upcoming earnings release dates, board of directors meeting dates, etc. They can also be organized according to market events, such as when a stock gaps up on one day and suffers a bearish reversal the next.

To organize the dashboard, select, from column 1, the event category, Corporate or Market, to use for organizing the selected instruments. For example, select the category of the event such as Earnings under Corporate Events or Up/Down under Market Events. The available events under the category will display in column 2 under the category header.

The current events selected can be read in column 3. For example, the events used to organize the dashboard may be earnings release dates when the stock is up very big. The user can also shift the events in time. For example, the user may wish to see earnings that are released today and when the stock was up big the day before. This can be accomplished using checkboxes in Column 3 of the screener to allow this type of analysis. The checkboxes are used to offset the date that the event actually happened from the date used for organization of the dashboard. The user need only select a “T” checkbox for Earnings Release Dates and the “T-1” checkbox of Up Big, to say “Earnings are released today (T), and the stock was Up Big yesterday (T-1)”. In the described embodiment, any event can be shifted up to 3 days in the past or 3 days in the future using the shifting feature of T-3 up to T+3. For instance, Apple (AAPL) crossed above its 50-day average on Jul. 27, 2016, so selecting the T checkbox will list AAPL on the dashboard under the date Jul. 27, 2016. The T-1 checkbox is used to indicate that the event occurred on the day before the day used to organize the dashboard. So if T-1 is selected, AAPL will be listed under the date Jul. 28, 2016. Conversely, T+1 is used to indicate that we should list AAPL on the dashboard when it crosses above the 50-day average on the next day, so it would show on the dashboard under the date Jul. 26, 2016. In other embodiments, more or fewer numbers of days may be used.

In the described embodiment, if the user needs to know how an event is defined, the user should select the informational icon, and a modal will display the definition used.

Multiple events can be selected. An All/One or More selector may be used to specify whether the user wishes to see when all events occur on the same day or whether only some of the events occur on the same day. For example a user may wish to view stocks when all of the following conditions are met: (1) Earnings are to be released today and (2) the stock was up big yesterday. Alternatively, a user may wish to see when a stock is either (1) up very big today or (2) down very big yesterday. By default, the described embodiment sets the selector to choose all events. Also in the described embodiment, the dashboard uses toggle buttons so that dates can be organized by descending or ascending order. By default, the described embodiment sets the selector to descending.

The user can have more than one day's worth of selected events showing on the dashboard, and this may be defined by the input boxes and these input boxes define how many days before today and how many days after today to display on the dashboard. If no events are selected, the user cannot show events in the future.

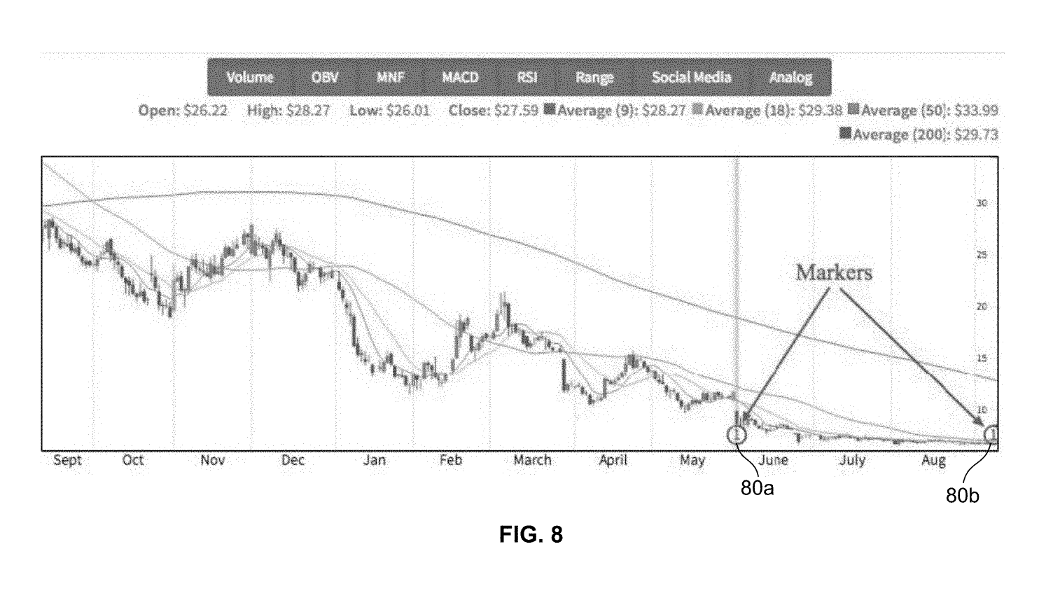

Referring back to FIG. 5, when the user has organized the dashboard by events, the user should select the chart customization button 62 to customize the graph. FIG. 8 shows a price graph customized to show specific markers on days that have certain events, as with marker 80a and marker 80b. These events may simply be the same as the events used to organize the dashboard, so the chart in FIG. 8 shows past dates on which the events selected also occurred.

The markers 80a-b may also highlight dates on which events unrelated to when selected events take place. For instance, the markers may not even be specific to the dashboard instrument on the chart. A dashboard screening for energy stocks may customize the chart so that it highlights OPEC meeting dates. The same is true of market events, such as Up Very Big. The user may customize a chart to highlight the days on which the dashboard stock is Up Very Big, and he or she may also choose to highlight days on which the Dow Index is Up Very Big. Selecting the markers to show on the graph is very similar to organizing the dashboard, as described above. Since the user used markers to show prior dates when the dashboard stock was organized, the user may simply migrate the event definitions by clicking an “Add Dashboard Events” button to add the markers to the graph.

There are only a handful of differences in the way charts are customized as opposed to the way that the dashboard is organized by events. First, when the user picks an event, such as Up Very Big, the user may shift this event in time using the T-3 though T+3 checkboxes. However, to avoid having an excess of repeated markers, the application picks the first checked boxed of the T-3 through T+3 if multiple boxes were picked when adding events. The second difference is that the user can select the dashboard stock or one of S&P 500, DJIA, Gold, or Oil.

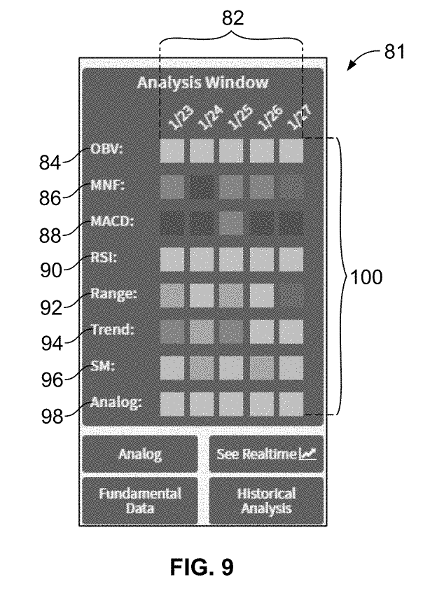

Referring back to FIG. 5, when the user has customized the chart, the user should select the indicator customization button 64 to customize indicators. Without customized indicators, if the user selects a stock from sample dashboard of instruments organized by dates (78 shown in FIG. 7), the user will see an analysis window 81 as shown in FIG. 9. FIG. 9 shows an analysis window 81 displaying the mapped indicators. The technical indicators are mapped as an indicator matrix. The analysis window 81 shows a date range 82 that the shown indicators cover. The indicators, as described above, are shown in successive rows as OBV 84, MNF 86, MACD 88, RSI 90, Range 92, Trend 94, Social Media 96, Analog 98. To the right of each indicator are indicator signals 100 that show a value based on color that the indicators had over the date range 82. The pattern, or map, shown by the indicator signals 100 over the date range 82 may be analyzed by the holder of the particular stock, and several maps may be shown together for further analysis. These concepts are explained in further detail below.

With the indicator customization button (64 in FIG. 5), the user may customize many things per dashboard. For example, the user can customize the indicators shown in the analysis window and below the chart. If the user only wants to show a chart with only MACD, RSI, and Trend, the user may select the desired indicators only. By default, the described embodiment selects all indicators, but the user can unselect the unwanted indicators using a selection bar, for example.

Users can also customize the indicators by choosing the colors used to display the indicator signals. The described embodiment uses default values as follows:
Very Bullish: Dark Green
Bullish: Light Green
Neutral: Orange
Bearish: Red
Very Bearish: Maroon
No Information: Gray

The indicators are used to define the T-Score, which is a single number that aggregates the value of the indicators over a number of days. The user can customize the T-Score computation by providing weights for each of the indicators in three ways. First, the user can provide different weights to each of the possible indicator signals. By default, the described embodiment assigns a 0 to neutral, 1 to bullish, −1 to bearish, 2 to very bullish, and −2 to very bearish, but these numbers can be freely changed, e.g., to give bearish signals a more negative weight than the equivalent bullish signals. Second, the user can assign different weights to the different signal types. By default the described embodiment weighs MNF three times more heavily than the other indicators, which are weighed evenly. Finally, in the described embodiment, the user can assign different weights to the different days. The T-Score can combine the indicator signals for up to six days, including the current day and the five days before. Other numbers of days may be used in other embodiments. By default, the described embodiment weighs the days using a scale of 50, 25, 20, 15, 10, and 5, so that the signals from the current day use a weight ten times more than the ones from five days before.

Referring back to FIG. 5, once the four steps described above have been completed, the user can preview their dashboard by selecting the preview button 70. In the described embodiment, the preview dashboard opens in a new browser tab and the user can see the watermark “PREVIEW” on the previewed dashboard. The user can then name the dashboard by putting a name in the dashboard name box 66, add a description in the description box 68 and then save the dashboard by selecting the save button 72.

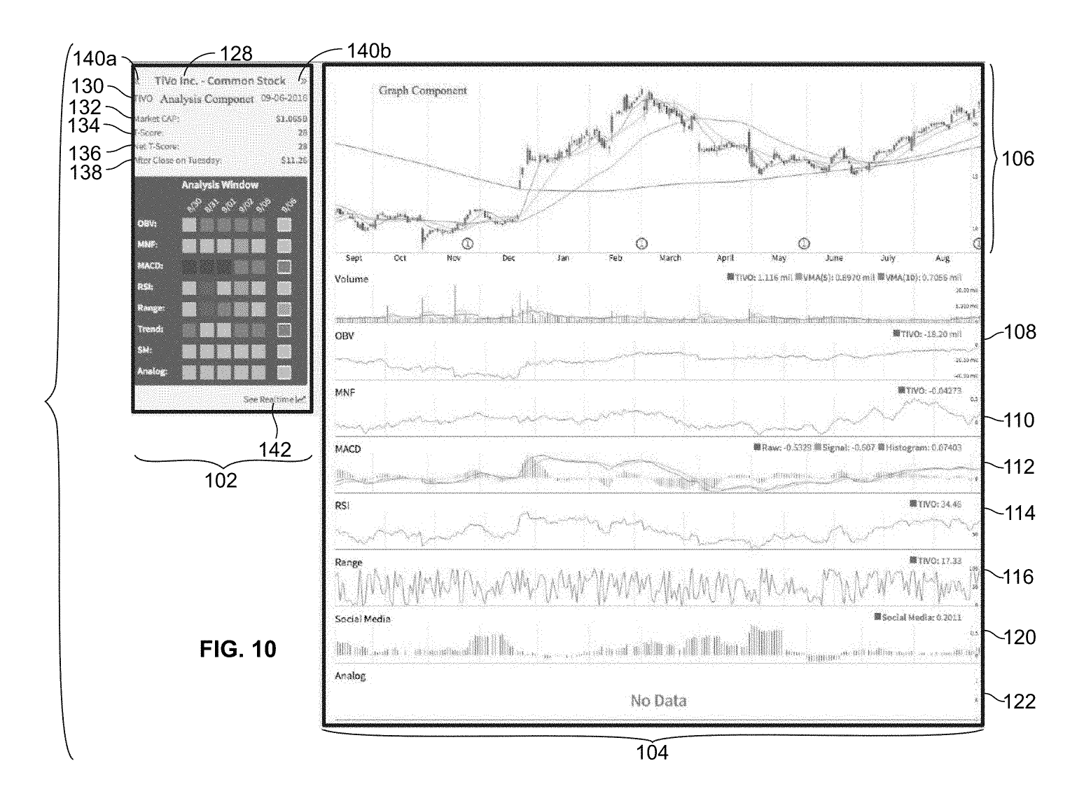

FIG. 10 shows a stock chart with an analysis component 102 and a graph component 104. The user can click on any ticker symbol 130 on a dashboard and bring up the stock chart of that ticker symbol 130.

The graph component 104, has a main price graph 106 of the stock and a possible seven mini-charts, corresponding to seven of the eight indicators described above (Trend is not shown). The seven mini-charts are the OBV chart 108, the MNF chart 110, the MACD chart 112, the RSI chart 114, the Range chart 114, the Social Media chart 120 and the Analog chart 122. The mini charts can be turned on and off by selecting a toggle button of the mini-charts located on the top of the main price graph. If the toggle button is green, the mini-chart is on. If the toggle button is blue, the mini-chart is off. A greater number of mini-charts may be used to correspond with other technical indicators.

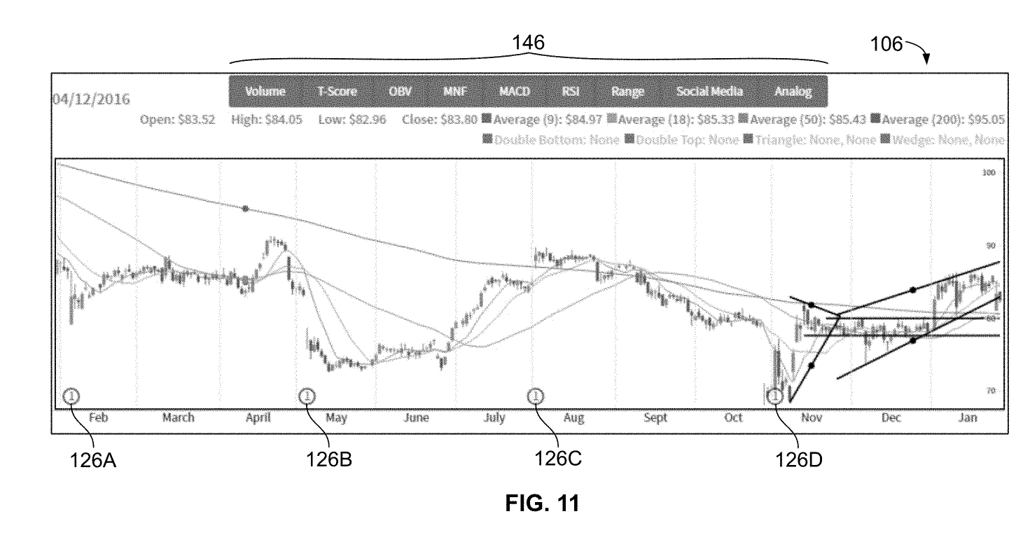

FIG. 11 shows a main price graph with indicator graph toggle buttons and event markers. The toggle buttons 124 are on top of the main price graph 106. The main chart on the graph component as seen in FIG. 11 is a price graph of open, high, low, and close. The 200 day, 50 day, 18 day, and 9 day average are displayed within the price graph. Event markers 126a-d, will be displayed on the graph if the user selects them when customizing the chart when building a dashboard. Placing a mouse over an event marker 126a-d will display, on the graph, what the market event is and give information about the event in the left hand corner of the graph, e.g. “Earnings report for Q2 2016: $1.68”. In the described embodiment, the patterns of triangles, wedges, double tops and double bottoms discovered in the stock in the last 90 days are drawn in the price graph in black. Head and shoulder patterns discovered in the stock in the last 180 days are also drawn in the price graph in black. The user can zoom in and out of the graphs by placing, not clicking, the mouse in the section of the price graph he or she wants to zoom into or out of, or the user can use his or her computer zoom buttons to control the trackpad or scrollbar of the mouse.

Referring back to FIG. 10, the analysis component 102 of the stock chart page is quite interesting and should be used to see the strength or weakness of the technical indicators of the stock for the last five days. Information such as the full name of the stock 128, the ticker symbol 130, the market cap 132, the T-Score 134 and Net T-Score 136, and the close price 138 are also on the analysis component 102. Clicking on the <<icon 140a and >>icon 140b will move the user to the next stock on the dashboard.

The user can get a fifteen minute delayed real time view of the selected stock by clicking on the see real time link 142. The link changes to say “See Indicators” when it is selected and a real time graph of the current day's trading is displayed under the area of the main price graph instead of the seven indicators.

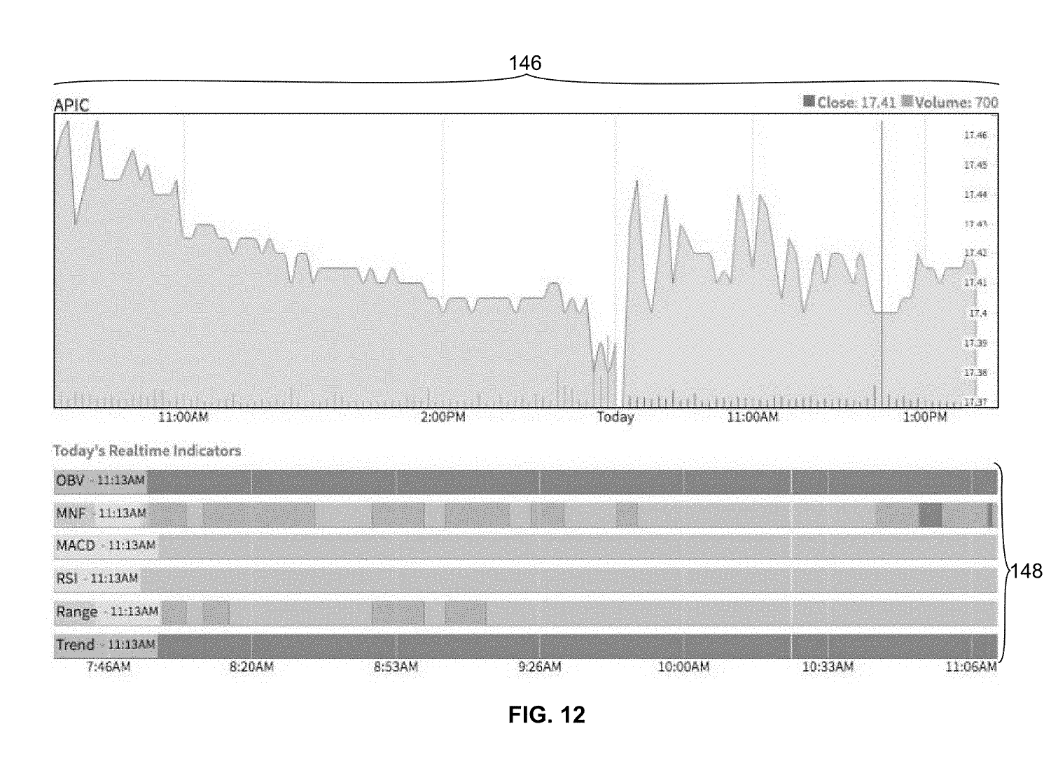

FIG. 12 shows a real time graph of the current day's trading with several technical indicators mapped. The user can easily return to the mini-graphs by selecting the link “See Indicators”. The indicator bars 148 underneath the real time view 146 are a time lapsed snapshot throughout the day of how the indicators change, and they do not have any association with the graph axis. This real time view is described in detail below with respect to watchlists.

In the described embodiment, the user can easily return back to the Earnings dashboard by selecting a three-bar menu icon in the left hand corner of the main menu or by using the browser back arrow. Moving between the stock chart and the dashboard is intended to be quick and easy.

In the described embodiment, every dashboard has a score page. The embodiment calculates a T-Score for every ticker on the dashboard page. As noted earlier, this T-Score is a single number that summarizes the technical analysis window using the specified weights for different days and different indicators. T-Scores range from −100 to 100 and they cluster around 0. Very positive T-Scores are indicative of upward price pressure and conversely very negative T-Scores are indicative of a downward trend in price. The Net T-Score is the T-Score subtracting the market bias (BETA) of a stock before the T-Score is computed. To get to the score page of a dashboard in the described embodiment, one may select a “Score” option from the dashboard on the main menu.

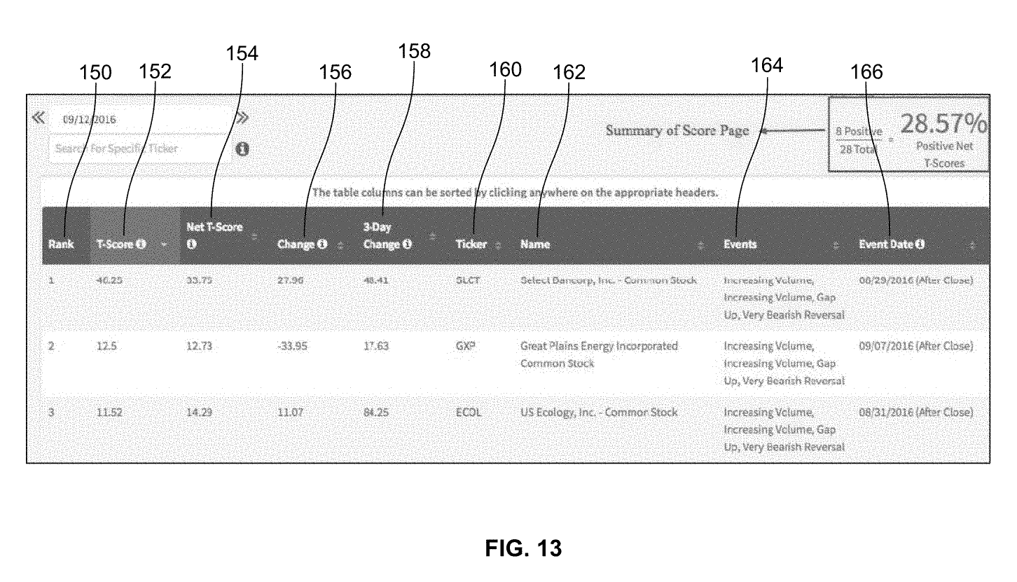

FIG. 13 shows a sample score page. The score page gives a quick summary of how all the stocks on the dashboard are doing. The date input box and find ticker input box function just as they do on all the other pages described herein. In FIG. 13, each column is described as follows. For Rank 150, the score page ranks each stock via the T-Score 152, highest to lowest. T-Score 152 is a single number that summarizes the technical analysis window using the specified weights for different days and different indicators. Net T-Score 154 is the T-Score 152 subtracting the market bias (BETA) of a stock before the T-Score 152 is computed. Change 156 is a ticker's T-Score 152 change, e.g. most improved or most declined, and is determined by the T-Score 152 of five, four and three days ago compared to the T-Score 152 of yesterday and today. 3 Day Change 158 is the T-Score 152 three day change and is determined by the single day T-Scores 152 of today and back to three days ago. Ticker 160 is the symbol of the Stock. Name 162 is the full name of the Stock. Events 164 describes the events in which the event date happens as selected when building the dashboard.

Event Date 166 shows event dates if your dashboard is organized by events as selected when building the dashboard. This date means one of two things. First, if the user has no events organizing the dashboard, this is the date that corresponds with the requested data. For example, the Commodities dashboard has no events so it shows the date for the chosen day. Second, if the user has events organizing the dashboard, this is the date that the event actually happens. For example, the Earnings dashboard's Event Date 166 is the release date of that ticker's earnings. In the described embodiment, each column on the score page is sortable by clicking the column heading.

The user can define how many entries load on the score page by default by using a page load indicator when present that shows the number of pages to display. Also, the user can display different pages of the score page by selecting a “next page” icon.

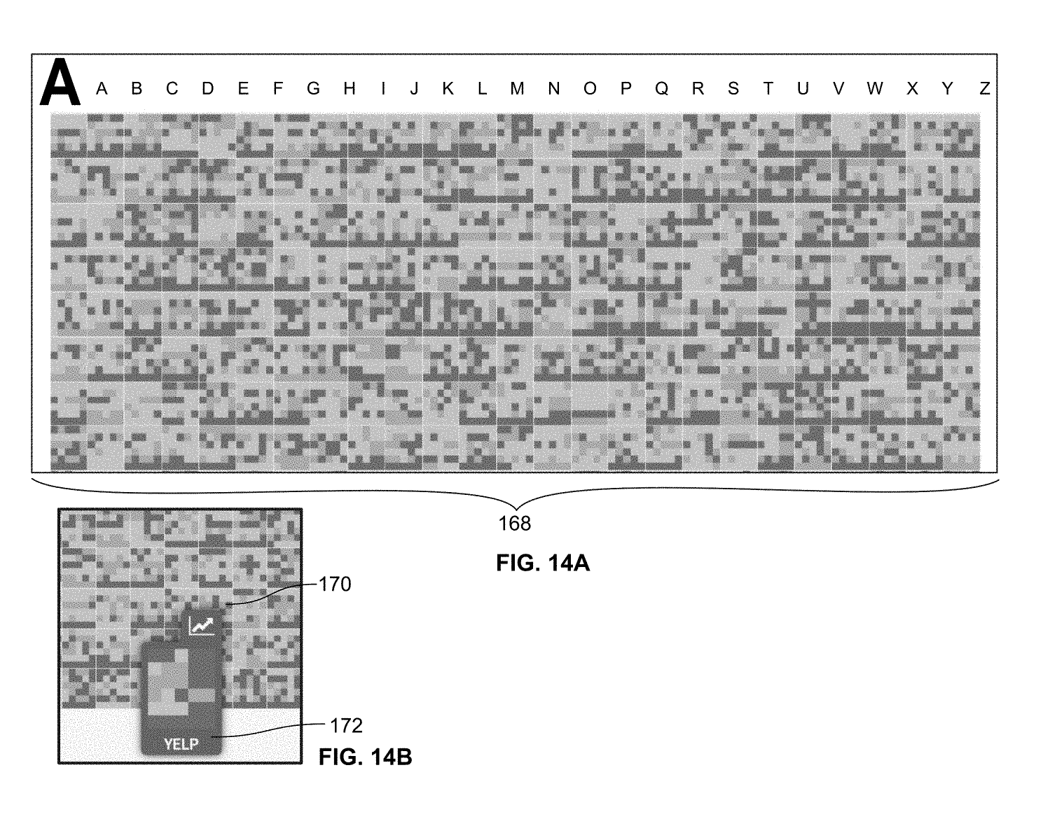

FIG. 14A shows a sample heat map page of mappings from a dashboard. The heat map page shows a graphical representation of the dashboard. Each ticker displays as a heat map 168 block with all indicators for the last five days for each stock on the dashboard. Its purpose is to give a quick overview of the strength or weakness of upcoming earnings as a whole, graphically. FIG. 14B shows a single block map view of a single stock enlarged over the heat map. As show in FIG. 14B, the user can hover over any block 170 in the heat map and select any stock to get a large block 172 view of the indicators and also to go to the graph of that stock.

The described embodiment has three built-in dashboards. One of them is Earnings, which shows stocks with upcoming earnings report release dates. As with all the built-in dashboards, the Earnings dashboard is built using the dashboard builder within the described embodiment. How this dashboard was built will be explained below.

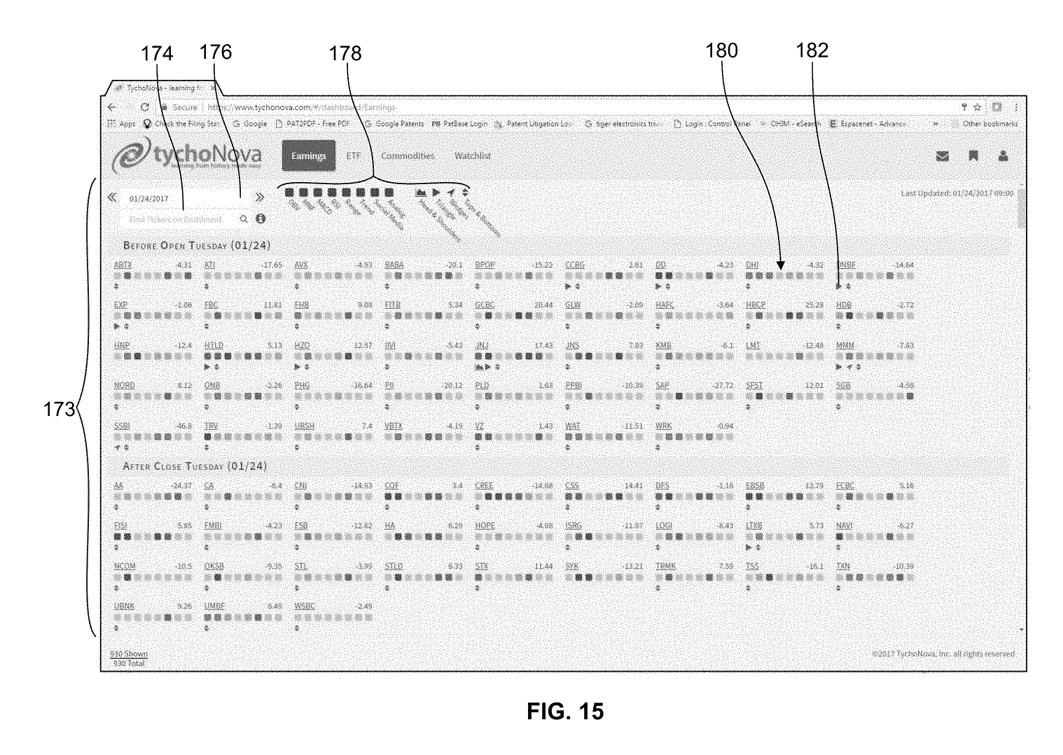

FIG. 15 shows the Earnings Dashboard 173. The Earnings Dashboard will display indicators 180 for the next seven trading days for stocks with upcoming earnings report release dates, excluding weekends, starting on the selected date in the date input box 176. The legend 178 describes what the indicators 180 show from left to right for the available indicators 180 followed by a legend 178 for patterns found in the performance graphs of the stocks. From left to right, the legend 178 defines the indicators 180 as OBV, MNF, MACD, RSI, Range, Trend, Social Media, and Analog, and the possible patterns as Head & Shoulders, Triangle, Wedges, and Tops & Bottoms. The user may also use the find ticker box 174 to find indicators 180 for a particular company.

By default, when the page loads, the date in the date input box 176 is the current date. So, if the date of 08/08/2016 is in the date input box 176, the Earnings Dashboard 173 will display upcoming earnings report dates for 8/8, 8/9, 8/10, 8/11, 8/12, 8/15, and 8/16 for 2016. FIG. 15 shows the date in the date input box 176 as 01/24/2017, so the Earnings dashboard 173 will show indicators 180 for stocks for companies releasing earnings reports through 01/30/2017. Because of the limitations of a standard computer screen, FIG. 15 only shows indicators 180 for stocks for companies releasing earnings reports before the open of trading on 01/24/2017 and after the close of trading on 01/24/2017.

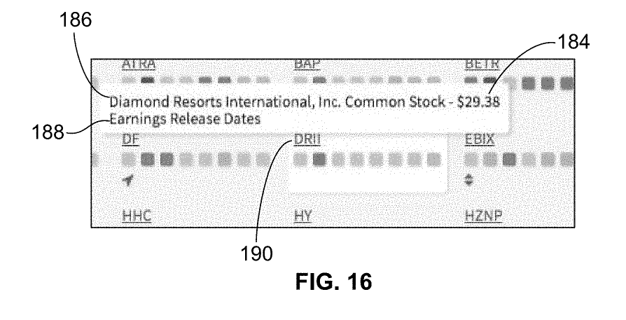

As with every dashboard, the Earnings Dashboard 173 is rich in data, and its purpose is to give the user a quick overview of the current strength or weakness of a stock with an upcoming earnings report release date using the defined technical indicators 180 and the patterns within the stock. The eight technical indicators 180 are displayed below the ticker symbol as colored boxes and the patterns 182 found within the stock are shown below the technical indicators 180. The legends 178 at the top of the Earnings dashboard 173 define the technical indicators 180 and patterns 182. The colors are either the default colors or the user defined colors. FIG. 16 shows ticker symbol information over a selected stock. If the user hovers the mouse on the ticker symbol link, the user will get the closing price 184 and the full company name 186 of the stock, and the event 188 (Earnings report date) in which the dashboard is organized. If the user clicks on the ticker symbol 190, the user will go to the stock chart page.

The Earnings Dashboard was built using the aforementioned dashboard wizard in four steps. In the first step, for example, the user may screen on “Last Close” under the category Price & Price Changes and set the value to a minimum of $10.00 so that the user only sees stocks that close above $10.00. If the user wants to show stocks with prices lower or greater, the user may slide the Last Close slider to the price range desired. An infinity symbol indicates the maximum. In the second step, the user may organize the dashboard with earning release dates for seven days in the future in ascending order. In the third step, the user may customize the chart page to have earning report release dates as event markers on the chart page. In the fourth step, the user may simply use defaults.

Another one of the built-in dashboards is the Commodities Dashboard. In the described embodiment, the Commodities Dashboard shows sixteen of the thirty-six possible commodities within the system. As with all the built-in dashboards, the Commodities Dashboard is built using the dashboard wizard within the described embodiment in four steps. As an example, the Commodities Dashboard will display, in descending order, the last seven trading days for Commodities, excluding weekends, starting on the selected date in the date input box. By default, the date is the current date. So, if the date 09/12/2016 is in the date input box, the dashboard will display upcoming earnings information for 09/12, 09/09, 09/08, 09/07, 09/06, 09/05, and 09/02.

The Commodities Dashboard was built using the aforementioned dashboard wizard in four steps. In the first step, the user may screen on the instrument “Commodities” and create a custom selection of the sixteen commodities desired on the dashboard. In the second step, the user may organize the dashboard by picking what the user wants to see, such as the dashboard dates in descending order. In this example, the user has not selected other events, so the dashboard will simply show seven days of data in descending order. In the third step, the user does not put any event markers on the chart page. In the fourth step, the user may simply use defaults.

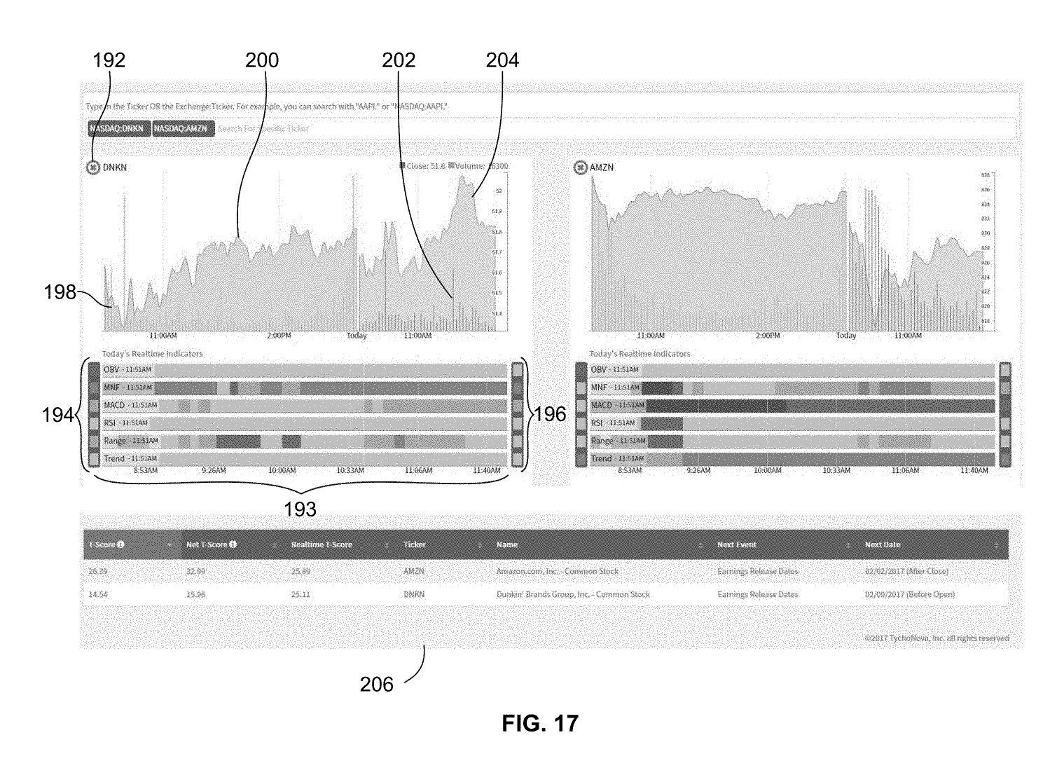

FIG. 17 shows a watchlist of stocks. In the described embodiment, the watchlist is global, not per dashboard, and the user can have up to twelve instruments on their watchlist, although other numbers of instruments are possible. The watchlist may be used for real time commodity spreads over a period of time in a panel as well as spreads for deferred contracts. A watch list with two stocks is shown in FIG. 17. Each stock is displayed with a live, fifteen-minute delayed feed that allows the user to track special stocks and their corresponding indicator colors throughout the day. The graph itself is broken into two parts, which may be different colors, such as blue and green. In this example, blue is yesterday's price graph 200 and green is today's price graph 204. Volume is indicated on the graph as orange vertical lines for yesterday volume 198 and red vertical lines for today's volume 202. Time is the X-axis of the price graph and price is the Y-axis. The time lapsed indicators 193, displayed as horizontal colored bars, change based on a live feed, and the user may put their mouse on a section of the horizontal time lapsed indicators 193 bar(s) to view the time and color of the indicator at that specific time in the day. These indicators do not share the same X-axis of the price graph. They are specifically today's indicators as of the open of the market today. Furthermore, the possible volume value is extrapolated based on the current volume and the previous volumes throughout the day. The watchlist is not specific to earnings. Yesterday's ending indicators 194 are positioned vertically and adjacent to the left side of the time lapsed indicators 193, and the current live indicators 196 vertically and adjacent to the right side of the time lapsed indicators 193 for quick monitoring.

The user can remove a stock from the watch list by selecting the remove stock button 192 on the top left of the price graph. Users may receive pop-ups on their screen when the indicators change. For example, if a stock's range indicator changed from bullish to neutral, these notices will appear to notify the user and disappear based on the site settings of pop-ups for the user. These pop-ups are meant to inform the user that an indicator has changed. In the described embodiment, the instruments on the user's watchlist persist from day to day if and only if the instrument is still on one of the user's favorite dashboards. Other configurations are possible. The table 206 below the watchlist lists the T-Score, the Net T-Score and the Real-time T-Score (calculated throughout the live feed) so that the user does not have to always return to the stock chart page for that information.

The described embodiment allows messaging between users. With messages, the user can send short notifications to, and share dashboards with, other users within their company, as well as receive important updates, such as release notices of features or changes. The user may access the messaging by pressing the message icon on the main menu. The icon shows the number of unread messages in the bottom right corner. The user can view all conversations in the user's inbox by pressing an inbox icon. The user will be able to view the most recent messages and the full conversation. When the user selects a message, the user will see the full conversation. From there, the user is able to add any attached dashboards that were sent within the message to the user's dashboards by clicking on a dashboard icon. The user can delete the conversation using a delete icon, or the user can reply to the conversation with a reply button. The user can also return to his or her inbox.

Users can write messages by either replying to an existing message or by selecting a new message icon. Users are able to send messages to all users within their company using a send icon. For example, a user may type in any available first or last name in order to find the person in a Send To area. Users can add multiple other users. Below the Send To area, the user will find a content area where the user can type their message. A user may attach dashboards to the message using an “Attach” icon. A user may clear out the current message by pressing a “Clear” icon. Once the message is ready to send, the user may send it using a “Send” icon. When attaching a dashboard to a message, the user is able to select any dashboards from the dashboard list. Attached dashboards will be highlighted. When a dashboard is sent to another user, a copy of that dashboard is created. This means that the user can change a dashboard or delete it after sharing it, and users will still receive the original dashboard as it was before it was shared.

The described embodiment has an Application Programming Interface (API). The output format is either JSON or CSV. Users can use this API to download any or all of the dashboard data. To generate a key to use the API, a user must go to site settings under the user icon.

In the described embodiment, users have the ability to customize some parameters, such as sounds used in sound alerts, pop-up window duration and API keys. Other settings are possible.

Using the described inventions has yielded the following wisdom: One should place more weight on the days closer to the earnings report release date (boxes further to the right of the Analysis Window). The five days in the Analysis Window are what are called the “set up”, which is either confirmed or negated by the “sixth day” with the heading meaning “NOW” on the real time graphs.

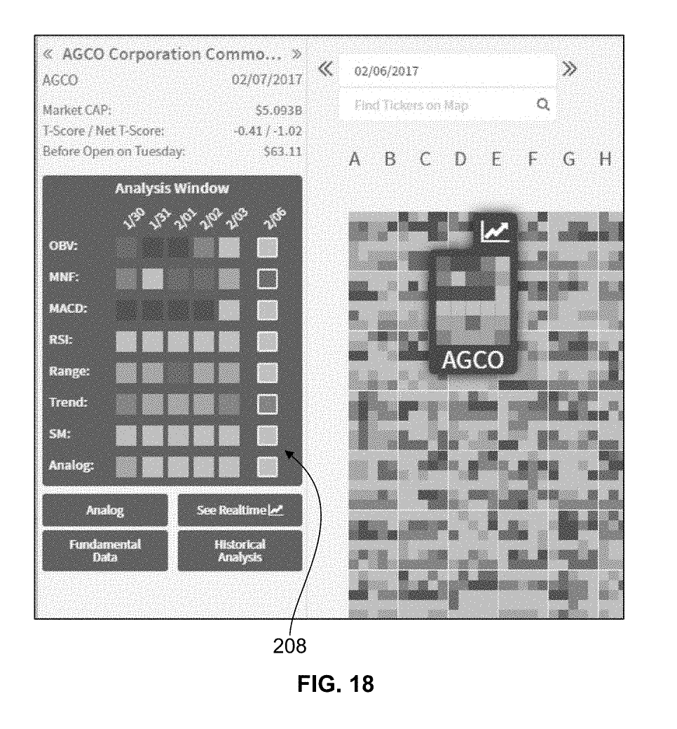

FIG. 18 shows an analysis window with a “sixth day” column 208. The sixth day column 208 is the most important day to watch closely because it is the last chance people have to make a move before the earnings are released. The system is enabled with near real time data (15 minute delay). The data can be seen by clicking “See Real-time” on the Analysis Component on the stock graph or on one's watchlist. One should monitor for the latest market trends. Put the greatest emphasis on Money Flow (MNF) when judging a stock. More “bearish” boxes are indicative of a probable miss, while more “bullish” boxes are indicative of a probable beat. In the above example, maroon boxes near the earnings date are indicative of highly bearish technical indicators, and dark green boxes near the earnings date are indicative of highly bullish technical indicators. If the previous day's indicator was highly negative and becomes highly positive, the greatest weight should be placed on the most recent day. A super strong sixth day column 208 will trump a bearish set up and vice versa. If one sees a chart that has mostly bearish and some highly bearish marks, but then on the sixth day column 208, the last day to get in a trade before earnings, and the boxes turn mostly bullish, then this is fodder for a potential short squeeze as many market participants no doubt see the bearish set up, but do not react too quickly to get out and/or switch positions to the long side.

The extra column (“sixth day” column 208) stems from what would be the “Now” column if one were viewing during the day. In FIG. 18, clicking “See Realtime” underneath the Analysis Window displays the “Now” column as if viewed during trading hours. The “Now” column is the real time T-Score, but that does not factor into the actual T-Score during the day. Thus it is not in the colored boxes seen on the dashboard. Once the nightly data process runs, the real time movements are factored in to make the new score and colored boxes (i.e. replacing the oldest day). Some embodiments may update those boxes on the dashboard so they are up to date intraday.

As a general rule, go long quality stocks and short garbage stocks. Use stops and money management skills. Do not place huge bets unless playing with the casino's money. Use reverse stops at times in case there is a huge move in the opposite direction. Use puts and calls to minimize risk and maximize return when possible. If torn between choices, pick stocks to go short that have a lot of debt and low returns on capital, and vice versa for longs. Observe other stocks in the same industry that have reported before the company you are examining. Observe unusual option action, e.g. the January CUDA 15 puts traded over 6,000 contracts by 1 pm with no open interest the day before. Do not short stocks with a high short interest that have already been beaten down.

While the present inventions have been illustrated by a description of various embodiments and while these embodiments have been set forth in considerable detail, it is intended that the scope of the inventions be defined by the appended claims. It will be appreciated by those skilled in the art that modifications to the foregoing preferred embodiments may be made in various aspects. It is deemed that the spirit and scope of the inventions encompass such variations to be preferred embodiments as would be apparent to one of ordinary skill in the art and familiar with the teachings of the present application.

What is claimed is:

1. A programmed computer-implemented system comprising:
an information producer that produces one or more source-related information records from one or more information providers in computer readable format with each source-related information record including a name of the source, a subject matter of the source-related information record, a current date, and further comprising:
a release date when the source will release a report containing information concerning the subject matter of the source-related information record; and
a plurality of links configured to attach further information as a recorded date and a discreet category from a set of categories to the source-related information record;
a social media monitor in communication with the information producer that monitors one or more social media sources comprising:
an input process configured to receive from the information producer for each of the one or more source-related information records the current date, the name of the source and the subject matter of the source-related information record; and
a query process in communication with the input process configured to, for each of the one or more source-related information records, monitor each of the one or more social media sources to find daily social media information about the source and the subject matter of the source-related information record and link the current date as a recorded date and the daily social media information found to the source-related information record;
a scheduled event manager in communication with the information producer and the social media monitor comprising:
a first tunable number configured to set the number of days before the current date for which to store daily social media information from the social media monitor; and
a second tunable number configured to create a second tunable number of particular discrete categories into which a process may categorize the daily social media information wherein the one or more source-related information records with the linked recorded dates and daily social media information corresponding to each recorded date; and
a categorization process to categorize and link the particular discrete category to the source-related information record.

2. The system recited in claim 1 wherein the categorization process is configured to find the linked recorded date and daily social media information for each of the one or more source-related information records for each of the recorded dates in each record from the first tunable number of days before the current date to the current date, to categorize the found relevant daily social media information into one of the particular discrete categories and to link the particular discrete category to the source-related information record, further comprising:
an output manager in communication with the scheduled event manager and configured to, for each of the one or more source-related information records, output the name of the source, the subject matter of the information, and for each of the links within each source-related information record with recorded dates from the date the first tunable number of days before the current date to the current date output the recorded date and the particular discrete category;
a computerized video display; and
a graphical output interface in communication with the output manager configured to show on the video display for each source-related information record the name of the source, the subject matter of the source-related information record, the release date, the current date, and a graphical representation of the particular discrete category.

3. The system recited in claim 2 further comprising the graphical output interface configured to show on the video display for each of the one or more source-related information records, the name of the source, the subject matter of the information, and for each of the links within each source-related information record with recorded dates from the date the first tunable number of days before the current date to the current date output the recorded date and the graphical representation of the particular discrete category.

4. The system recited in claim 3 further comprising the graphical output interface further configured to show graphical representations of values pertaining to categories related to the category of daily social media information that can be graphically represented with the same particular discrete categories as the daily social media information wherein the graphical representations of values pertaining to the related categories are juxtaposed in relation to the graphical representation of the daily social media information to give the graphical representations of values pertaining to the related categories and the graphical representation of the daily social media information meaning based on the juxtaposition.

5. The system recited in claim 4 wherein the output manager and the graphical output interface are further configured to, for a source-related information record for each of the recorded dates from the first tunable number of days before the current date to the current date, create a graphical arrangement by graphically arranging on the computerized video display for visual scanning the juxtapositions of the graphical representations of values pertaining to the related categories and the graphical representation of the daily social media information.

6. The system recited in claim 5 wherein the output manager and the graphical output interface are further configured to, for each of the one or more source-related information records, juxtapose the corresponding graphical arrangements to give the graphical arrangements meaning based on the juxtaposition.

7. The system recited in claim 4 further comprising the graphical output interface further configured to display the juxtaposition of the graphical representations of values pertaining to the related categories and the graphical representation of the daily social media information as a user interface dashboard arranged according to release dates.

8. The system recited in claim 4 wherein for each of the one or more source-related information records the name of the source is a company name, the subject matter of the source-related information record is earnings, and the release date is the date that the company will release its earnings report.

9. The system recited in claim 8 wherein the first tunable number is six and the particular discrete categories are very bullish, bullish, neutral, bearish, very bearish, and no information and wherein the graphical representations of each of the particular discrete categories are different color squares and the categories related to the category of daily social media information are On Balance Volume (OBV), Chaikin Money Flow (MNF), Moving Average Convergence/Divergence (MACD), Relative Strength Index (RSI), Percentage of last Close within the High-Low Range (Range), a comparison of moving averages versus price (Trend) and the predicted price movement in the next ten days (Analog).

10. The system recited in claim 6 wherein for each of the one or more source-related information records the name of the source is a company name, the subject matter of the source-related information record is earnings, and the release date is the date that the company will release its earnings report.

11. The system recited in claim 10 wherein the first tunable number is six and the particular discrete categories are very bullish, bullish, neutral, bearish, very bearish, and no information and wherein the graphical representations of each of the particular discrete categories are different color squares and the categories related to the category of daily social media information are On Balance Volume (OBV), Chaikin Money Flow (MNF), Moving Average Convergence/Divergence (MACD), Relative Strength Index (RSI), Percentage of last Close within the High-Low Range (Range), a comparison of moving averages versus price (Trend) and the predicted price movement in the next ten days (Analog).

12. The system recited in claim 11 wherein the first tunable number is five.

13. A system for detecting advance earning report insider information comprising:
an information producer that produces one or more company-related information records from one or more information providers in computer readable format with each company-related information record comprising:
the name of a company;
the subject matter defined as earnings;
the current date;
a release date when the company will release an earnings report; and
a plurality of links configured to attach further information as a recorded date and a discreet category from a set of categories to the company-related information record;
a social media monitor in communication with the information producer that monitors one or more social media sources comprising:
an input process configured to receive from the information producer for each of the one or more company-related information records the name of the company and earnings as the subject matter of the company-related information record; and
a query process in communication with the input process configured to, for each of the one or more company-related information records, monitor each of the one or more social media sources to find daily social media information about the company and the earnings of the company and link the current date as a recorded date and the daily social media information found to the company-related information record;
a scheduled event manager in communication with the information producer and the social media monitor comprising:
a first tunable number setting the number of days before current date for which to store daily information from the social media monitor;
a second tunable number configured to create a second tunable number of particular discrete categories into which a process may categorize the daily media information;
the one or more company-related information records with the linked recorded dates and daily social media information corresponding to each recorded date; and
a categorization process configured to find the linked recorded date and daily social media information for each of the one or more company-related information records for each of the recorded dates from the first tunable number of days before the current date to the current date, to categorize the found relevant daily social media information into one of the particular discrete categories and to link the particular discrete category to the company-related information record;
an output manager in communication with the scheduled event manager and configured to, for each of the one or more company-related information records, output the name of the source, earnings as the subject matter of the information, and for each of the links within each company-related information record with recorded dates from the date the first tunable number of days before the current date to the current date output the recorded date and the particular discrete category;
a computerized video display; and
a graphical output interface in communication with the output manager configured to show on the video display for each company-related information record the name of the company, the subject matter of the company-related information record, the release date, the current date, and a graphical representation of the particular discrete category.

14. The system recited in claim 13 further comprising the graphical output interface configured to show on the video display for each of the one or more company-related information records, the name of the company, earnings as the subject matter of the information, and for each of the links within each company-related information record with recorded dates from the date the first tunable number of days before the current date to the current date output the recorded date and the graphical representation of the particular discrete category.

15. The system recited in claim 14 further comprising the graphical output interface further configured to show graphical representations of values pertaining to categories related to the category of daily social media information that can be graphically represented with the same particular discrete categories as the daily social media information wherein the graphical representations of values pertaining to the related categories are juxtaposed in relation to the graphical representation of the daily social media information to give the graphical representations of values pertaining to the related categories and the graphical representation of the daily social media information meaning based on the juxtaposition.

16. The system recited in claim 15 wherein the output manager and the graphical output interface are further configured to, for a company-related information record for each of the recorded dates from the first tunable number of days before the current date to the current date, create a graphical arrangement by graphically arranging on the computerized video display for visual scanning the juxtapositions of the graphical representations of values pertaining to the related categories and the graphical representation of the daily social media information.

17. The system recited in claim 16 wherein the output manager and the graphical output interface are further configured to, for each of the one or more company-related information records, juxtapose the corresponding graphical arrangements to give the graphical arrangements meaning based on the juxtaposition.

18. The system recited in claim 17 wherein the first tunable number is six and the particular discrete categories are very bullish, bullish, neutral, bearish, very bearish, and no information and wherein the graphical representations of each of the particular discrete categories are different color squares and the categories related to the category of daily social media information are On Balance Volume (OBV), Chaikin Money Flow (MNF), Moving Average Convergence/Divergence (MACD), Relative Strength Index (RSI), Percentage of last Close within the High-Low Range (Range), a comparison of moving averages versus price (Trend) and the predicted price movement in the next ten days (Analog) and wherein the first tunable number is five.

19. A method for detecting advance earning report insider information comprising:
producing one or more company-related information records from one or more information providers in computer readable format with each company-related information record comprising:
the name of a company;
the subject matter defined as earnings;
the current date;
a release date when the company will release an earnings report; and
a plurality of links configured to attach further information as a recorded date and a discreet category from a set of categories to the company-related information record;
monitoring one or more social media sources with a social media monitor comprising:
communicating with the input producer to receive from the information producer for each of the one or more company-related information records the name of the company and earnings as the subject matter of the company-related information record; and
querying with a query process in communication with the input process by for each of the one or more company-related information records monitoring each of the one or more social media sources, finding daily social media information about the company and the earnings of the company and linking the current date as a recorded date and the daily social media information found to the company-related information record;
monitoring one or more social media sources using a social media monitor in communication with the information producer comprising:
configuring an input process to receive from the information producer for each of the one or more company-related information records the name of the company and earnings as the subject matter of the company-related information record; and
monitoring for each of the one or more company-related information records each of the one or more social media sources to find daily social media information about the company and the earnings of the company and linking the current date as a recorded date and the daily social media information found to the company-related information record using a query process in communication with the input process;
providing a scheduled event manager in communication with the information producer and the social media monitor comprising:
setting a first tunable number to the number of days before current date for which to store daily information from the social media monitor;
setting a second tunable number configured to create a second tunable number of particular discrete categories into which a process may categorize the daily media information;
the one or more company-related information records with the linked recorded dates and daily social media information corresponding to each recorded date; and
configuring a categorization process for finding the linked recorded date and daily social media information for each of the one or more company-related information records for each of the recorded dates from the first tunable number of days before the current date to the current date, categorizing the found relevant daily social media information into one of the particular discrete categories and linking the particular discrete category to the company-related information record;
providing an output manager in communication with the scheduled event manager and configured for, for each of the one or more company-related information records, outputting the name of the source, earnings as the subject matter of the information, and for each of the links within each company-related information record with recorded dates from the date the first tunable number of days before the current date to the current date outputting the recorded date and the particular discrete category;
providing a computerized video display;
displaying a graphical output interface in communication with the output manager configured to show on the video display for each company-related information record the name of the company, the subject matter of the company-related information record, the release date, the current date, and a graphical representation of the particular discrete category;
showing on the video display for each of the one or more company-related information records, the name of the company, earnings as the subject matter of the information, and for each of the links within each company-related information record with recorded dates from the date the first tunable number of days before the current date to the current date outputting the recorded date and the graphical representation of the particular discrete category;
showing graphical representations of values pertaining to categories related to the category of daily social media information that can be graphically represented with the same particular discrete categories as the daily social media information wherein the graphical representations of values pertaining to the related categories are juxtaposed in relation to the graphical representation of the daily social media information to give the graphical representations of values pertaining to the related categories and the graphical representation of the daily social media information meaning based on the juxtaposition; and
setting the first tunable number to six and the particular discrete categories to very bullish, bullish, neutral, bearish, very bearish, and no information wherein the graphical representations of each of the particular discrete categories are different color squares and the categories related to the category of daily social media information are On Balance Volume (OBV), Chaikin Money Flow (MNF), Moving Average Convergence/Divergence (MACD), Relative Strength Index (RSI), Percentage of last Close within the High-Low Range (Range), a comparison of moving averages versus price (Trend) and the predicted price movement in the next ten days (Analog) and wherein the first tunable number is five.

20. The method recited in claim 19 further comprising:
configuring the output manager and the graphical output interface to, for a company-related information record for each of the recorded dates from the first tunable number of days before the current date to the current date, create a graphical arrangement by graphically arranging on the computerized video display for visual scanning the juxtapositions of the graphical representations of values pertaining to the related categories and the graphical representation of the daily social media information; and
configuring the output manager and the graphical output interface to, for each of the one or more company-related information records, juxtapose the corresponding graphical arrangements to give the graphical arrangements meaning based on the juxtaposition.
